(19) United States
(12) Patent Application Publication
(10) Pub. No.: US 2002/0042284 A1
(43) Pub. Date: Apr. 11, 2002

(54) Method and arrangement for ensuring continuous transmission power control despite of discontinuous transmission

(76) Inventors: Sebire Benoist, Espoo (FI); Eero Nikula, Espoo (FI)

Correspondence Address: PERMAN & GREEN, 425 POST ROAD, FAIRFIELD, CT, 06430, US

(21) Appl. No.: 09/971,335

(22) Filed: Oct. 3, 2001

(30) Foreign Application Priority Data
Oct. 9, 2000 (FI) 20002228

(51) Int. Cl. H04B 7/00

(52) U.S. Cl. 455/522; 455/69

(57) ABSTRACT

A method and devices are disclosed for conveying information related to fast power control between a mobile sation and a radio access network in a cellular radio system. Frames of payload information are transmitted during certain first period of an active circuit-switched communication connection, said first period corresponding to a period where payload information exists for transmission. Information related to fast power control is inserted into the frames of payload information transmitted during said first period of an active circuit-switched communication connection. The transmission of frames of payload information is temporarily discontinued for the duration of a certain second period of an active circuit-switched communication connection, said second period corresponding to a period where payload information temporarily does not exist for transmission. Updating messages are transmitted according to a certain timetable during said second period. Information related to fast power control is insrted into the updating messages transmitted during said second period of an active circuit-switched communication connection.

### TECHNOLOGICAL FIELD

The invention concerns generally the task of controlling the transmission power of radio transmitters in a cellular radio system. Especially the invention concerns the task of making the power control mechanisms independent of the possibly discontinuous nature of payload transmissions.

### BACKGROUND OF THE INVENTION

Discontinuous transmission, also known by the acronym DTX, is a method where, in a radio communications device taking part in a circuit-switched communication connection, the radio transmitter is only switched on during those periods for which there is meaningful payload information to be transmitted. As an example, a radio telephone using DTX will only have its radio transmitter on during the periods when its user is actually speaking. The advantages gained through the application of DTX are mainly related to savings in transmitter power consumption and a decrease in the general level of radio interference experienced by other simultaneous communication connections.

On the other hand, fast power control that is also known by the acronym FPC is an arrangement applied in cellular radio systems where the transmission power of either a base station or a mobile station or both is controlled in a fast feedback loop. In a typical FPC arrangement both the base station and the mobile station monitor the power level or other feature of the radio signals received over an active communication connection. The base station converts its monitoring results into power control commands that it sends with little additional delay to the mobile station so that the latter can quickly adapt its transmission power to counteract fluctuations noticed at the base station. In the other direction the mobile station sends its monitoring results back to the base station, so that it is left to the base station to decide, whether it should change the transmission power used for transmissions to that particular mobile station. An exemplary FPC method and arrangement is described in the technical specifications “Digital Cellular Telecommunications System (Phase 2+), Channel Coding (GSM 05.03 version 8.5.0 Release 1999” and “Digital Cellular Telecommunications System (Phase 2+), Radio Subsystem Link Control (GSM 05.08 version 8.5.0 Release 1999”, which are published by the European Telecommunications Standards Institute and incorporated herein by reference.

The FPC method disclosed in said technical specifications depends on the continuous transmission of payload data bursts in both uplink and downlink directions, because FPC-related information is mapped on certain so-called stealing flag symbols of the payload data bursts. The mobile station inserts the so-called fast signal quality reports into the payload data bursts that it sends in the uplink direction, and the base station inserts the fast power control commands into the payload data bursts that it sends in the downlink direction. Obviously, discontinuous transmission would interfere with such a fast power control arrangement, because silencing the payload transmissions in the uplink direction would prevent the fast signal quality reports from reaching the base station and silencing the payload transmissions in the downlink direction would correspondingly prevent the fast power control commands from reaching the mobile station.

Said technical specifications have specified the use of the fast power control arrangement described therein to the context of Enhanced Circuit Switched Data, also known as ESCD, where DTX is not used and consequently no problems are to be expected. However, essentially the same fast power control arrangement has been suggested for use on the 8PSK-modulated AMR speech traffic channels of GERAN (eight-level Phase Shift Keying; Adaptive Multi-Rate, General EDGE Radio Access Network, where EDGE comes from Enhanced Datarates for GSM Evolution). Discontinuous transmission will also be applied on these channels, which means that the fast power control arrangement in its known form would not work properly.

### SUMMARY OF THE INVENTION

It is an object of the present invention to provide a method and an arrangement for enabling fast power control also on circuit-switched traffic channels where discontinuous transmission is used.

The objects of the invention are achieved by reverting, for the purposes of transmitting information related to fast power control, to certain regularly transmitted updating messages during the pauses in payload transmission that are caused by discontinuous transmission.

The features that are characteristic to the method according to the invention are recited in the characterising portion of the independent method claim.

The invention applies also to a mobile station and a base station. The characteristic features of the mobile station according to the invention are recited in the characterising portion of the independent patent claim directed to a mobile station. The characteristic features of the base station according to the invention are recited in the characterising portion of the independent patent claim directed to a base station.

The AMR speech traffic channels specified for GERAN comprise the feature of scantly but regularly transmitting so-called updating messages during a pause caused by discontinuous transmission. The original purpose of these updating messages, which in the specific context of the AMR speech traffic channels specified for GERAN are also known as SID_UPDATE messages, is to update the generated comfort noise on the receiving side, to convey AMR in-band signalling and to improve the measurement of the link quality by the radio subsystem. According to the present invention, information related to fast power control could be added into the updating messages.

According to the invention, when a discontinuity period starts on an AMR speech channel, the transmitting device redirects the FPC-related information that it has to transmit into a unit that composes and transmits the SID_UPDATE messages. Similarly the start of a discontinuity period causes the receiving device to immediately look into the SID_UPDATE messages it receives, in order to find the FPC-related information that it used to receive within speech bursts before the discontinuation.

The known structure of SID_UPDATE messages as well as the known channel coding and burst formatting procedures used in their transmission are not optimally suited for the addition of FPC-related information. Therefore, according to a certain aspect of the invention, it is also proposed that the modulation level used in transmitting SID_UPDATE messages is increased e.g. by employing 8PSK-modulation instead of GMSK (Gaussian Minimum Shift Keying). The increasing vulnerability to interference brought up by the introduction of a higher-level modulation method is more or less compensated for by the fact that the transmission capacity in bits per unit time is simultaneously remarkably increased, allowing more effective channel coding methods to be used. The physical location within the SID_UPDATE messages that is suitable for accommodating the FPC-related information is for example the set of stealing flag symbols the appearance of which is known as such.

### BRIEF DESCRIPTION OF DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates the principle of the invention,

FIG. 2 illustrates a known way of generating SID_UPDATE bursts,

FIG. 3 illustrates an exemplary way of adding FPC-related information into SID_UPDATE bursts,

FIG. 4 illustrates another exemplary way of adding FPC-related information into SID_UPDATE bursts,

FIG. 5 illustrates another exemplary way of adding FPC-related information into SID_UPDATE bursts,

FIG. 6 illustrates an aspect of a method according to an embodiment of the invention,

FIG. 7 illustrates another aspect of a method according to an embodiment of the invention and

FIG. 8 illustrates another aspect of a method according to an embodiment of the invention.

### DETAILED DESCRIPTION OF THE INVENTION

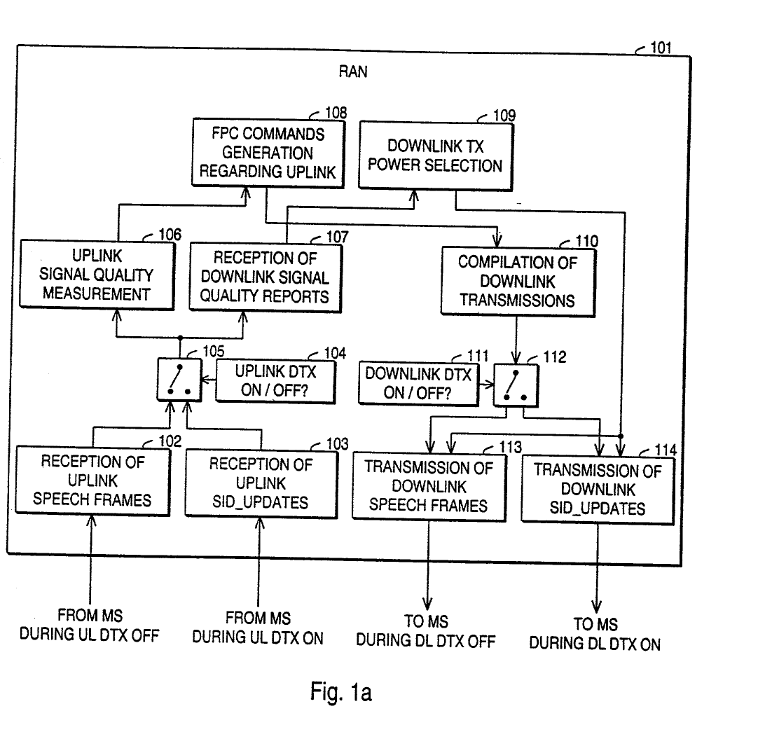

FIG. 1 illustrates, in its part shown as FIG. 1a in the drawings, schematically certain functions of a radio access network 101 according to an embodiment of the invention. The radio access network 101 is called the RAN for short. It is equipped for receiving both speech frames and updating messages from mobile stations. To comply with the customary terminology in the field, the updating messages are in the following called the SID_UPDATE messages. The reception means for speech frames and SID_UPDATE messages are shown separately in FIG. 1a as blocks 102 and 103 respectively, although physically there is typically only one receiver that receives whatever there is to be received.

There is, within the RAN 101, a certain functional unit 104 the task of which is to know, whether actual payload transmission is on in the uplink direction or whether there is a pause caused by discontinuous transmission. These situations are known as the UL DTX OFF and UL DTX ON conditions respectively. In the functional diagram of FIG. 1a this unit 104 uses a switch 105 to couple the output of either the speech reception means 102 or the SID_UPDATE reception means 103 to uplink signal quality measurement 106 and reception of quality reports 107. The latter means the reception of reports that describe signal quality observed by a mobile station in the downlink direction. From the uplink signal quality measurement function 106 there is a coupling to the generation of uplink fast power control commands at block 108 that are to be conveyed to the mobile station. From the reception of quality reports function 107 there is a coupling to the selection of downlink transmission power at block 109.

The compilation of downlink transmissions is schematically shown in FIG. 1a as block 110. It receives, among others, as input information the uplink FPC commands originating from block 108. Correspondingly to unit 104 there is, within the RAN 101, a certain functional unit 111 the task of which is to know, whether actual payload transmission is on in the downlink direction or whether there is a pause caused by discontinuous transmission. In the functional diagram of FIG. 1a this unit 111 uses a switch 112 to couple the output of the downlink transmission compiler 110 either to the transmission of speech frames at functional block 113 or to the transmission of downlink SID_UPDATE messages at functional block 114.

FIG. 1 illustrates also, in its part shown as FIG. 1b in the drawings, schematically certain functions of a mobile station 121 according to an embodiment of the invention. The mobile station 121 is called the MS for short. It is equipped for receiving both speech frames and updating messages from radio access networks. The updating messages are again called the SID_UPDATE messages. The reception means for speech frames and SID_UPDATE messages are shown separately in FIG. 1b as blocks 122 and 123 respectively, although physically there is typically only one receiver that receives whatever there is to be received.

There is, within the MS 121, a certain functional unit 124 the task of which is to know, whether actual payload transmission is on in the downlink direction or whether there is a pause caused by discontinuous transmission. These situations are known as the DL DTX OFF and DL DTX ON conditions respectively. In the functional diagram of FIG. 1b this unit 124 uses a switch 125 to couple the output of either the speech reception means 122 or the SID_UPDATE reception means 123 to downlink signal quality measurement 126 and reception of FPC commands 127. The latter means the reception of the commands that a RAN has generated on the basis of the uplink signal quality measurements that it has performed. From the downlink signal quality measurement function 126 there is a coupling to the generation of downlink signal quality reports at block 128. From the reception of FPC commands function 127 there is a coupling to the selection of uplink transmission power at block 129.

The compilation of uplink transmissions is schematically shown in FIG. 1b as block 130. It receives, among others, as input information the downlink signal quality reports originating from block 128. Correspondingly to unit 124 there is, within the MS 121, a certain functional unit 131 the task of which is to know, whether actual payload transmission is on in the uplink direction or whether there is a pause caused by discontinuous transmission. In the functional diagram of FIG. 1b this unit 131 uses a switch 132 to couple the output of the uplink transmission compiler 130 either to the transmission of speech frames at functional block 133 or to the transmission of downlink SID_UPDATE messages at functional block 134.

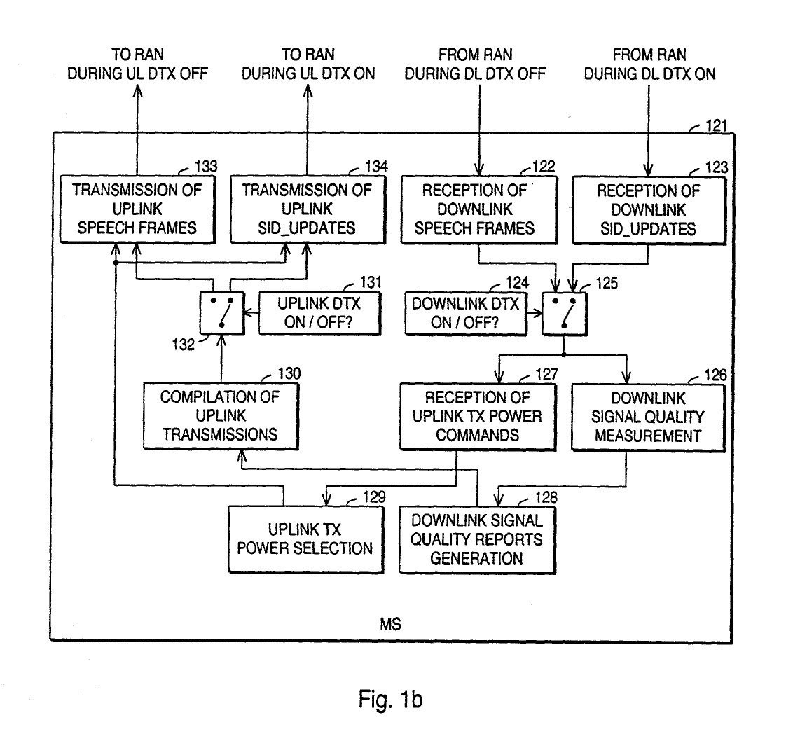

In order to give some additional background to the insertion of FPC-related information into SID_UPDATE messages, FIG. 2 is discussed briefly. According to prior art, comfort noise parameters 201, an identification marker 202 and in-band data for the purpose of link adaptation 203 were combined (multiplexed) 210 in a certain order to produce a SID_UPDATE block 211. This combined block was subjected to channel coding 220 at a coding ratio of approximately ½. The channel coded SID_UPDATE block 221 was split and interleaved in a burst formatting operation 230 to produce four SID_UPDATE bursts 231, 232, 233 and 234. GMSK modulation 240 was used to modulate a carrier wave in the transmission of the bursts.

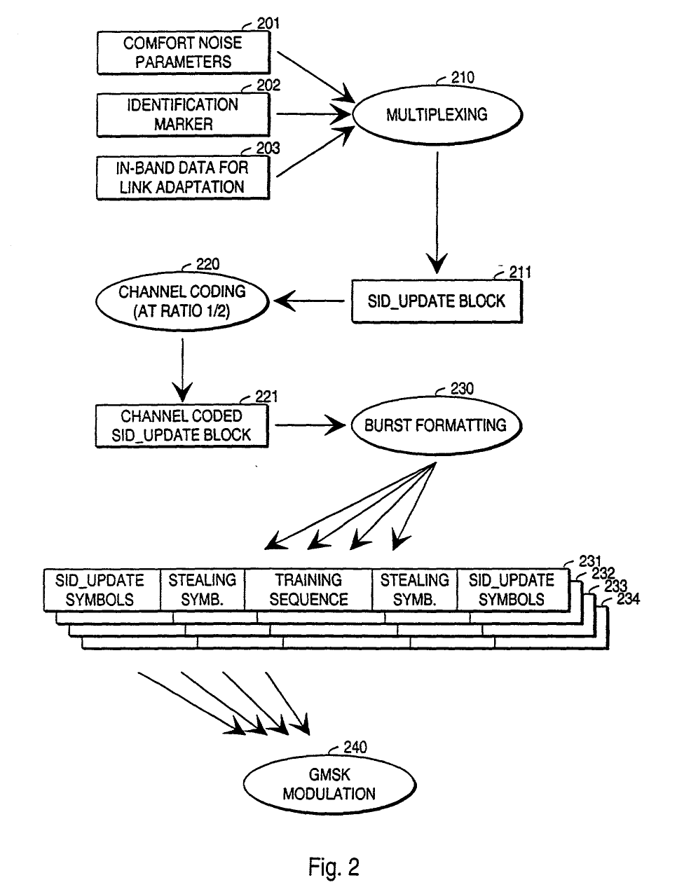

According to the invention, FPC-related information is combined with the SID_UPDATE bursts. Several possibilities exist for accomplishing this task. FIG. 3 shows an alternative where in addition to a channel coded SID_UPDATE block 221′, also FPC-related information 322 is given as input information to the burst formatting step 230′. In the latter the FPC-related information 322 is mapped into the stealing symbol positions to produce the FPC-carrying bursts 331, 332, 333 and 334. These are used in an 8PSK modulation step 340 to produce the actual RF transmission bursts. The three-fold bit capacity of 8PSK means that a different coding ratio must be used at the channel coding step 221′, making the coding ratio now to be approximately ⅙. This decrease in coding ratio, which means that heavier channel coding is used, compensates for the fact that when modulation order is increased, the C/I (carrier to interference) requirements at reception get more difficult.

In the known structure of a GMSK-modulated SID_UPDATE burst there are two stealing symbols in each burst. In GMSK this means that each stealing symbol is the equivalent of one bit in transmission. Tripling the bit capacity means that also each stealing symbol may now convey the equivalent of three bits. There are four bursts related to each SID_UPDATE block, which means that the method of FIG. 3 allows 24 FPC-related bits to be transmitted per each SID_UPDATE block. Taken that the SID_UPDATE blocks are transmitted according to the known timetable where the first SID_UPDATE block occurs t=2*20 ms after the DTX ON condition has been reached and subsequent SID_UPDATE blocks occur at t=2*20 ms+n*8*20, where n=1, 2, 3 . . . , this embodiment of the invention enables the transmission of enough FPC-related bits per unit time for implementing effective fast power control.

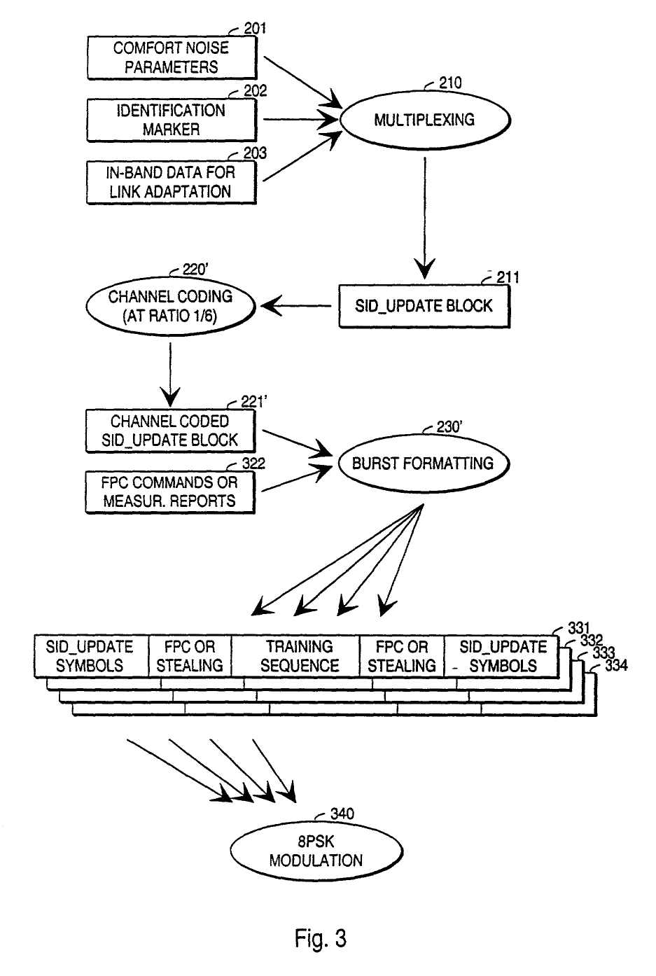

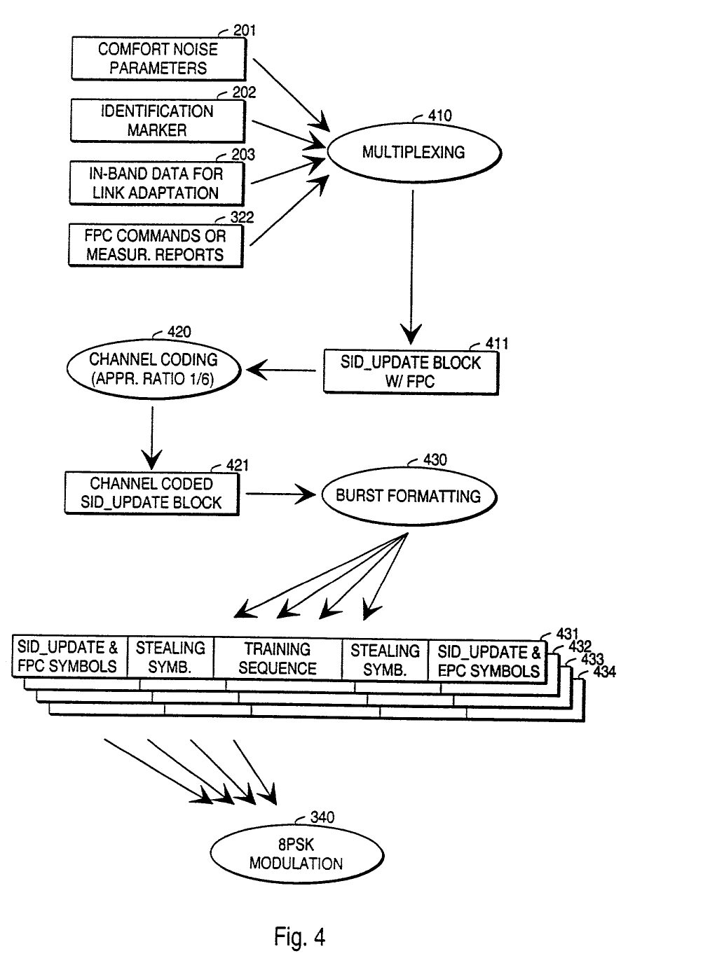

FIG. 4 illustrates another alternative where the additional bit capacity resulting from the use of 8PSK modulation 340 is partly used to convey the FPC-related information in the payload parts of the bursts 431, 432, 433 ja 434. In this case the FPC-related information is another piece of input information already into the multiplexing step 410. If the amount of FPC-related information per burst is limited, then also the method shown in FIG. 5 is applicable. Here the procedure is otherwise the same as in FIG. 3, but instead of using the values of the stealing symbols, the burst formatting block 230′ maps the FPC-related information into the training sequences of the bursts 531, 532, 533 and 544 by selecting into each burst an appropriate one from a limited number of allowable training sequences. If the number of allowable training sequences is K, the number of discrete FPC-related values that can be conveyed per SID_UPDATE block by using the method of FIG. 5 is K⁴. If this method is used for conveying the FPC-related information, any modulation method can be used for the SID_UPDATE bursts.

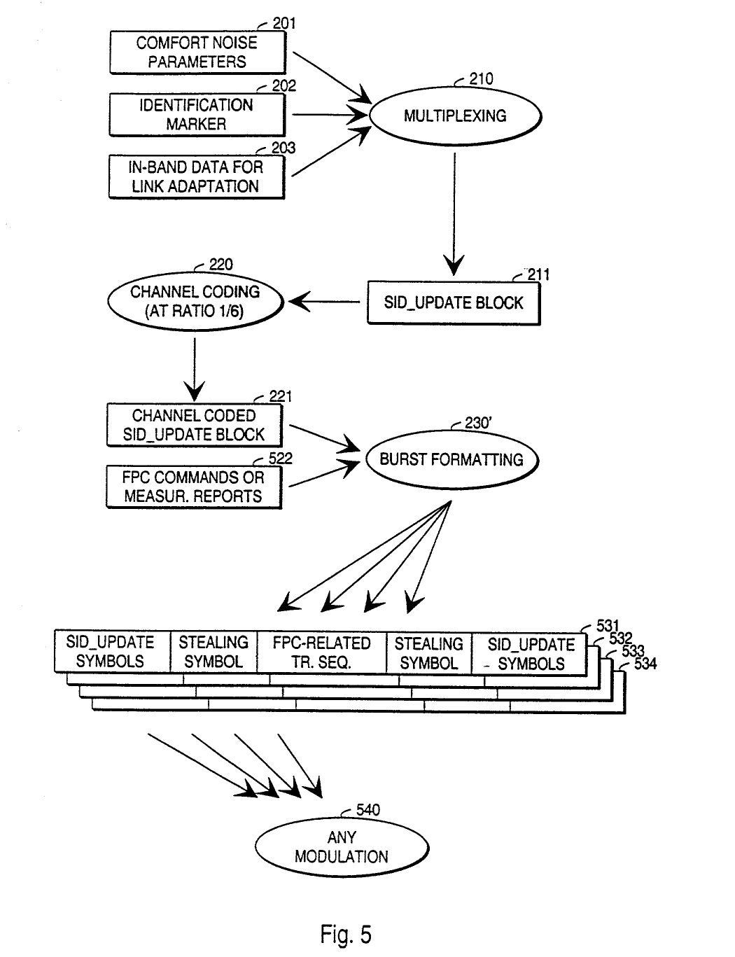

When either a mobile station or a network element in a radio access network is executing a method according to the invention, its operation may be coarsely characterised by the states shown in FIG. 6. A kind of a basic state is state 601 where DTX is not on in either direction and all FPC-related information is transmitted in the speech frames. If uplink DTX goes on, a transition to state 602 occurs where FPC-related information to be transmitted in the uplink direction goes into the SID_UPDATE messages. Uplink DTX going off causes a return to state 601. A transition from state 601 to state 603 is a result of downlink DTX going on; in state 603 FPC-related information to be transmitted in the downlink direction goes into the SID_UPDATE messages. Again DTX going off causes a return to state 601. If, during state 602 or 603 also the DTX in the other direction goes on, there occurs a transition to state 604 where all FPC-related information goes into the SID_UPDATE messages. The occurrence of exactly simultaneous DTX on/off transitions (e.g. uplink DTX going off simultaneously with downlink DTX going on) is not shown in FIG. 6 because such occurrences are rare; however it is straightforward for the person skilled in the art to see also the state transitions they would cause in FIG. 6.

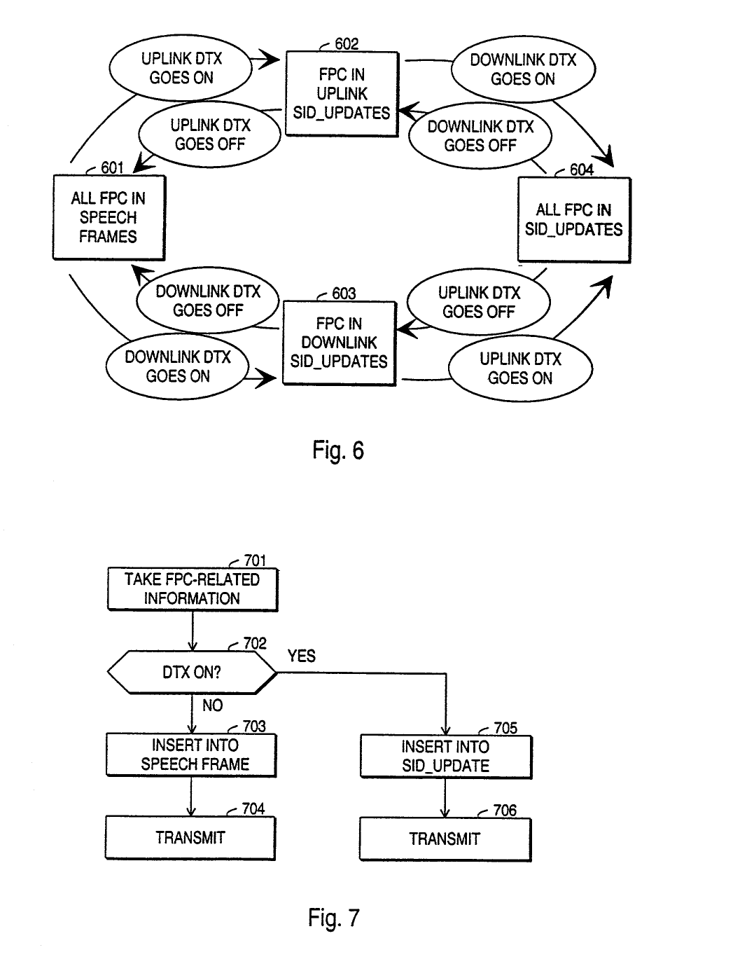

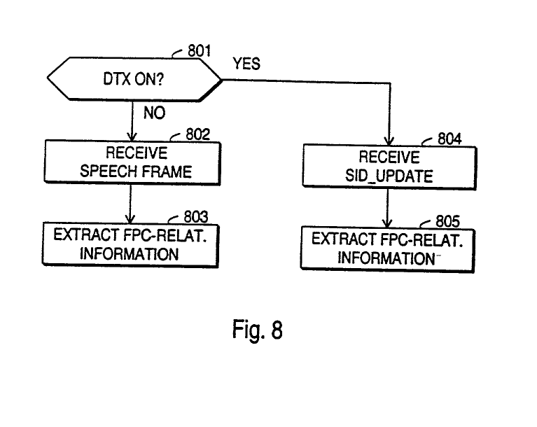

FIGS. 7 and 8 are simple flow diagrams that illustrate the operation of either a mobile station or a network element in a radio access network in transmitting (FIG. 7) or receiving (FIG. 8) FPC-related information. In FIG. 7 whenever the device has FPC-related information to transmit according to step 701, it examines at step 702 whether DTX is on in the direction concerning transmission. If no, it inserts the piece of FPC-related information into a speech frame at step 703 and transmits the speech frame at step 704. If DTX was on, the device inserts the piece of FPC-related information into a SID_UPDATE message at step 705 and transmits the message at step 706. In FIG. 8 when the device is about to receive FPC-related information it examines according to step 801, whether DTX is on in the direction concerning reception. If no, it receives a speech frame at step 802 and extract the piece of FPC-related information from the speech frame at step 803. If DTX was on, the device receives a SID_UPDATE message at step 804 and extract the piece of FPC-related information from the SID_UPDATE message at step 805.

The hardware components required to implement the method according to the invention in a mobile station or a network element in a radio access network are basically similar to known hardware elements, with the exception that a control block that controls the placing of pieces of FPC-related information and the possibly associated changes in modulation and channel coding arrangements must be programmes to execute the methods described above. Such programming is as such believed to be within the capabilities of a person skilled in the art.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

1. A method for conveying information related to fast power control between a mobile sation and a radio access network in a cellular radio system, comprising the steps of:
transmitting frames of payload information during certain first period of an active circuit-switched communication connection, said first period corresponding to a period where payload information exists for transmission,
inserting information related to fast power control into the frames of payload information transmitted during said first period of an active circuit-switched communication connection,
temporarily discontinuing the transmission of frames of payload information for the duration of a certain second period of an active circuit-switched communication connection, said second period corresponding to a period where payload information temporarily does not exist for transmission,
transmitting updating messages according to a certain timetable during said second period, and
inserting information related to fast power control into the updating messages transmitted during said second period of an active circuit-switched communication connection.

2. A method according to claim 1, wherein the step of inserting information related to fast power control into the updating messages comprises the step of selecting the values of certain stealing symbols within certain updating bursts according to the contents of the information related to fast power control that is to be transmitted.

3. A method according to claim 1, wherein the step of inserting information related to fast power control into the updating messages comprises the step of multiplexing the information related to fast power control that is to be transmitted with the other information contents of certain updating messages.

4. A method according to claim 1, wherein the step of inserting information related to fast power control into the updating messages comprises the step of selecting the form of certain training sequences within certain updating bursts according to the contents of the information related to fast power control that is to be transmitted.

5. A mobile station equipped for maintaining communication connections with radio access networks of cellular radio networks, the mobile station comprising:
means for transmitting frames of payload information to a network element of a radio access network during certain first period of an active circuit-switched communication connection, said first period corresponding to a period where payload information exists within the mobile station for transmission,
means for receiving frames of payload information from a network element of a radio access network during certain second period of an active circuit-switched communication connection, said second period corresponding to a period where payload information exists within the network element for transmission,
means for inserting information related to fast power control into the frames of payload information to be transmitted during said first period of an active circuit-switched communication connection,
means for extracting information related to fast power control from the frames of payload information received during said second period of an active circuit-switched communication connection,
means for temporarily discontinuing the transmission of frames of payload information for the duration of a certain third period of an active circuit-switched communication connection, said third period corresponding to a period where payload information temporarily does not exist within the mobile station for transmission,
means for transmitting updating messages according to a certain timetable during said third period,
means for receiving updating messages during a certain fourth period of an active circuit-switched communication connection, said fourth period corresponding to a period where payload information temporarily does not exist within the network element for transmission,
means for inserting information related to fast power control into the updating messages transmitted during said third period of an active circuit-switched communication connection, and
means for extracting information related to fast power control from the updating messages received during said fourth period of an active circuit-switched communication connection.

6. A network element within a radio access network equipped for maintaining communication connections with mobile stations of cellular radio networks, the network device comprising:
means for transmitting frames of payload information to a mobile station of a cellular radio network during certain first period of an active circuit-switched communication connection, said first period corresponding to a period where payload information exists within the network element for transmission,
means for receiving frames of payload information from a mobile station of a cellular radio network during certain second period of an active circuit-switched communication connection, said second period corresponding to a period where payload information exists within the mobile station for transmission,
means for inserting information related to fast power control into the frames of payload information to be transmitted during said first period of an active circuit-switched communication connection,
means for extracting information related to fast power control from the frames of payload information received during said second period of an active circuit-switched communication connection,
means for temporarily discontinuing the transmission of frames of payload information for the duration of a certain third period of an active circuit-switched communication connection, said third period corresponding to a period where payload information temporarily does not exist within the network element for transmission,
means for transmitting updating messages according to a certain timetable during said third period,
means for receiving updating messages during a certain fourth period of an active circuit-switched communication connection, said fourth period corresponding to a period where payload information temporarily does not exist within the mobile station for transmission,
means for inserting information related to fast power control into the updating messages transmitted during said third period of an active circuit-switched communication connection, and
means for extracting information related to fast power control from the updating messages received during said fourth period of an active circuit-switched communication connection.
